(19) United States
(12) Patent Application Publication
(10) Pub. No.: US 2014/0180654 A1
(43) Pub. Date: Jun. 26, 2014

(54) Client Finite Element Submission System

(71) Applicant: Stephen Michael Seymour, Edmond, OK (US)

(72) Inventor: Stephen Michael Seymour, Edmond, OK (US)

(21) Appl. No.: 14/138,062

(22) Filed: Dec. 21, 2013

Related U.S. Application Data
(60) Provisional application No. 61/745,636, filed on Dec. 23, 2012.

(51) Int. Cl. G06F 17/50

(52) U.S. Cl. CPC G06F 17/5009
USPC 703/2

(57) ABSTRACT

The embodiments of the Client Finite Element Submission System are comprised of a means to allow the user to create the job file package to be submitted to the Finite Element Analysis (FEA) professional. The job file package will include the the geometry to be analyzed, simulation type specifications, material specifications, boundary conditions, and custom result requests. Each analysis model will appear in the analysis tree as a new branch. At this point the user will submit the design and for analysis by the FEA professional. Once the design is complete the user will receive a completion email acknowledgement with a URL link providing a means to download the results file. The Client Finite Element Submission System application allows the user to review the results. The plurality of analysis types includes structural, modal, pre-stress static structural and pre-stressed modal thermal and coupled thermal structural analysis.

### CROSS-REFERENCE TO RELATED APPLICATIONS

This application is a non-provisional patent application of pending U.S. provisional patent application with Ser. No. 61/745,636 titled “Client Finite Element Submission System” filed on Dec. 23, 2012. This application claims priority of U.S. provisional patent application with Ser. No. 61/745,636, and the entire contents of U.S. provisional patent application with Ser. No. 61/745,636 is herein incorporated by reference.

### STATEMENT REGARDING FEDERALLY SPONSORED RESEARCH OR DEVELOPMENT

Not applicable

### FIELD OF THE EMBODIMENTS

The field of the embodiments is Finite Element Analysis modeling applications.

### BACKGROUND OF THE EMBODIMENTS

Finite Element Analysis (FEA) is a numerical simulation technique for determining the structural response of product designs or geometries based on a set of applied boundary conditions that come in the form including forces, constraints, accelerations, and applied temperatures. FEA is used today within modern engineering and manufacturing facilities to lower development costs associated and compress development timelines associated with product designs by simulating the product design within a virtual environment based upon applied operational conditions or operational requirements.

Unfortunately, the cost barrier associated with implementing or acquiring FEA capabilities can be prohibitive for small or even medium sized companies. Companies have two options currently for utilizing FEA within product development: 1) purchase the FEA software and hardware for in-house utilization, or 2) enlist the consulting services of a professional mechanical engineer or a consulting firm. The costs of both of these approaches can often prove too high to the small business or occasional user of FEA technology. With purchasing FEA software for in-house use the costs associated with internal implementation can be quite large ranging upwards of $20,000 to enter the low-end market at upwards of $100,000 to enter the custom application market with a fully trained employee.

In addition to the up-front and annual costs associated with obtaining in-house FEA capabilities, the timelines associated can be lengthy. For instance, because of the time required for purchasing approvals, purchase order submittal, software vendor registration and licensing, the time lapse from the moment the decision to obtain in-house FEA capabilities from the completion of software training for the end user can be weeks or months.

Another option at the disposal of small business to utilize FEA within their product development would be to enlist the consulting services of an independent engineer or engineering consulting firm. However, this option too can prove to be both costly and time prohibitive. For instance, most engineering consulting firms and individuals charge a rate of $125 to $150 per hour of service. Even for small simulation projects most consultants and engineering firms will charge a 3 to 4 hour minimum in order to cover the costs associated with the analysis specifications, quotation, and results presentation or reporting. And, this is just a minimum. If the simulation itself takes 1 to 2 hours that will be cost added to the typical minimum. Therefore, for even small simulation requests the cost for small business can be between $500 and $1000. Furthermore, many consulting firms have a current customer job queue and obtaining results can take many weeks in some instances.

In the standard operations of FEA where the customer who wishes to have a design simulated by FEA, the customer or user provides the computer-aided design professional with a rough sketch or rudimentary CAD design to complete the application. Alternatively the user could purchase and be trained in computer-aided design or finite element analysis, typically called CAD or FEA software. The latter process typically takes a great amount of resources on the part of the user to accomplish. FEA software is particularly difficult to use and especially to master. In addition, the initial cost of purchasing the FEA software is usually prohibitive for the standard user. Large users who routinely draft and design mechanical parts can invest in the software and the training necessary to use FEA software; however, the small or occasional user is at a significant disadvantage in the marketplace for performing these calculations.

What will be advantageous to the small or occasional user is a means of providing the CAD or FEA professional with a rudimentary drawing and a method of submitting that drawing to the FEA professional and receiving results back from the FEA professional.

### SUMMARY OF THE EMBODIMENTS

In summary, the embodiments of the Client Finite Element Submission System are comprised of a pre-processing package, which generates a job file package, and a post-processing package.

The pre-processing package is comprised of a means to allow the user to create the job file package to be submitted to the Finite Element Analysis (FEA) professional. The job file package will include the geometry to be analyzed, simulation type specifications, material specifications, boundary conditions, and custom result requests. The pre-processing package comprises the means to allow the user to specify multiple analysis models. Each analysis model will appear in the analysis tree as a new branch. In addition the user will have the ability to duplicate or copy each analysis branch to create another analysis branch. At this point the user will submit the design and for analysis by the FEA professional. Once the design is complete the user will receive a completion email acknowledgement with a URL link providing a means to download the results file. The FEA OD application allows the user to review the results. There is a plurality of analysis types that could be specified by the user and performed by the FEA professional. The plurality of analysis types includes structural, modal, pre-stress static structural and pre-stressed modal thermal and coupled thermal structural analysis. Defining the types of objects that will be done on the various analysis types.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a flow diagram of an embodiment of the Client Finite Element Submission System showing the overall flow of the system.

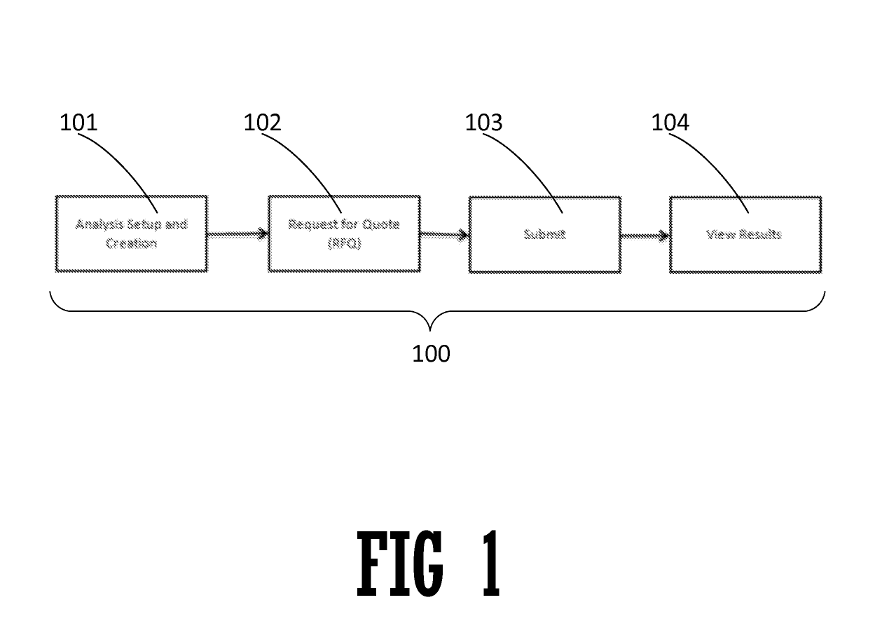

FIG. 2 is a screen image of the hierarchal menu of an embodiment of the Client Finite Element Submission System.

FIG. 3 is a flow diagram of an embodiment of the Client Finite Element Submission System showing the flow of the system specifying the type of analyses to be performed and the materials to be used.

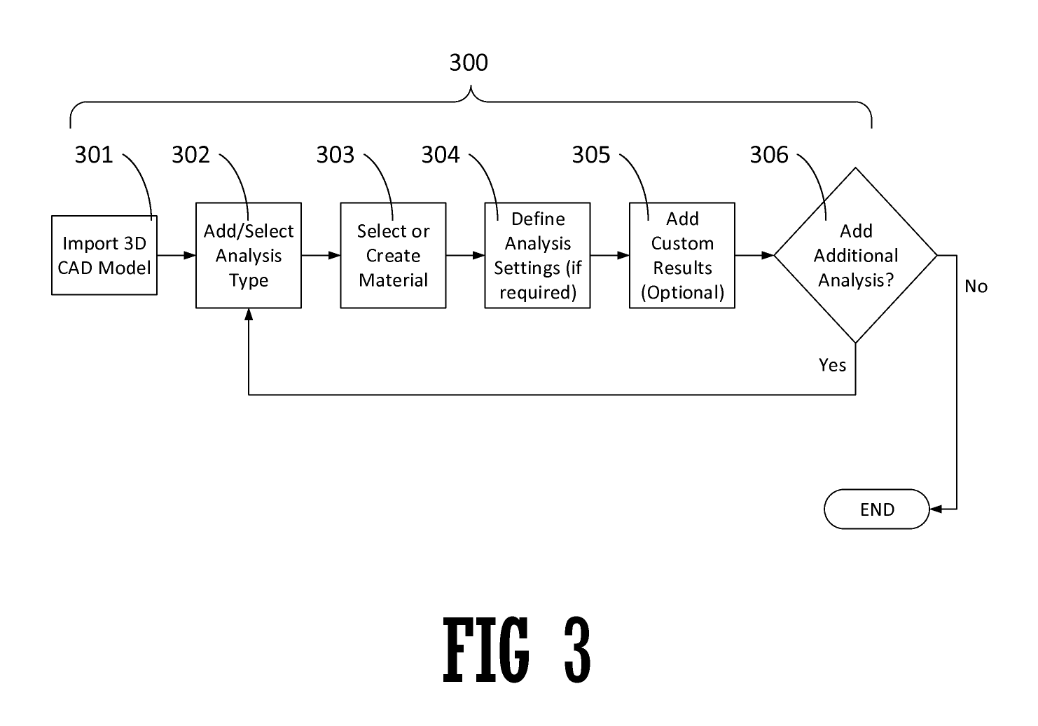

FIG. 4 is a flow diagram of an embodiment of the Client Finite Element Submission System showing the flow of the system specifying the type of client delivery options.

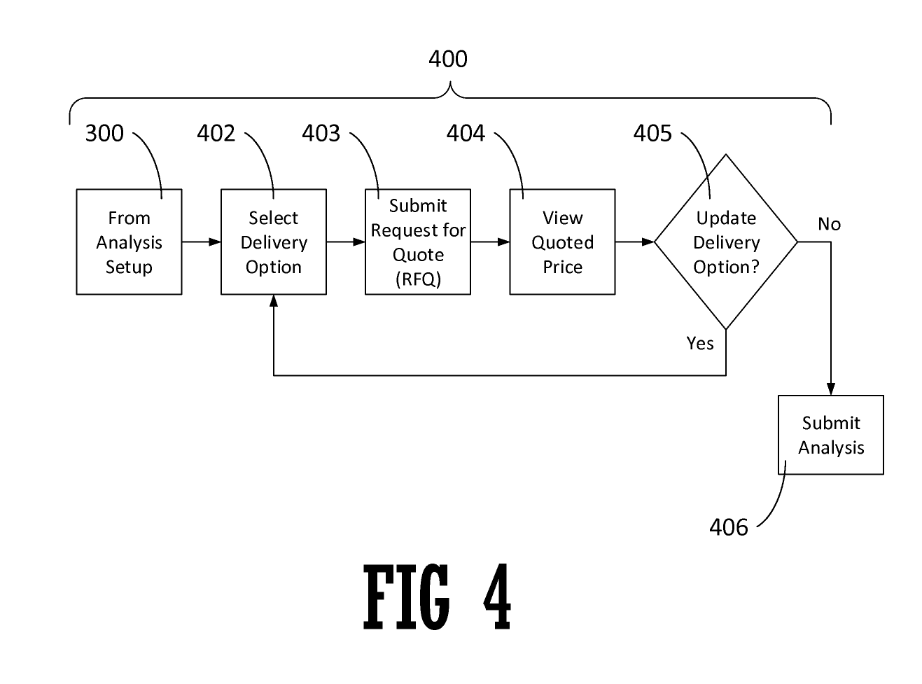

FIG. 5 is a flow diagram of an embodiment of the Client Finite Element Submission System showing the flow of the system specifying the type of client payment options.

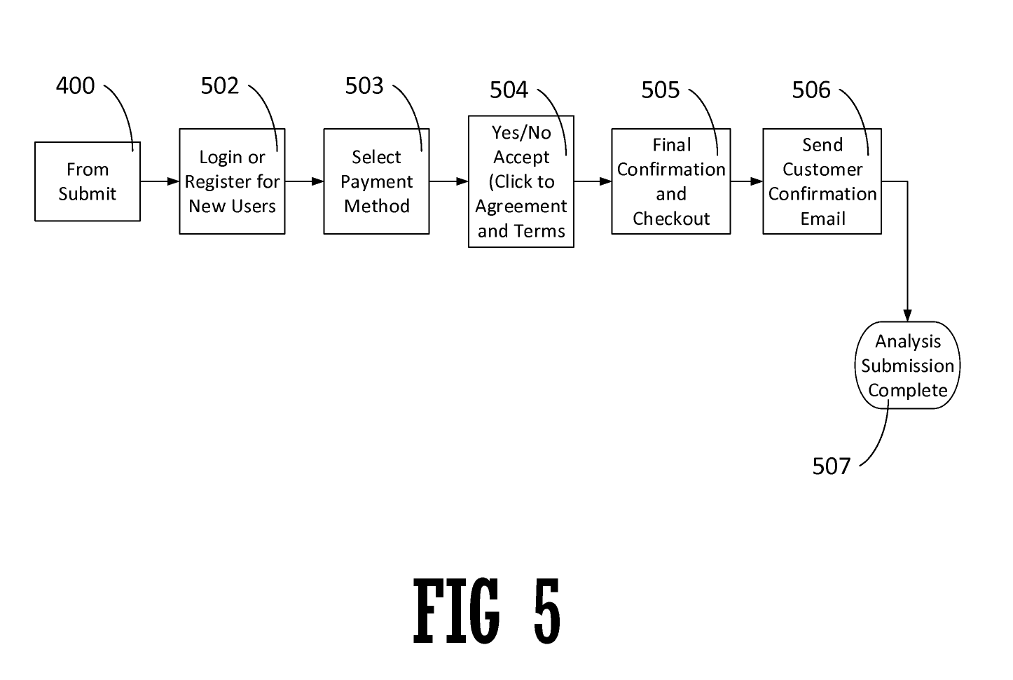

FIG. 6 is a flow diagram of an embodiment of the Client Finite Element Submission System showing a portion of the flow of the system.

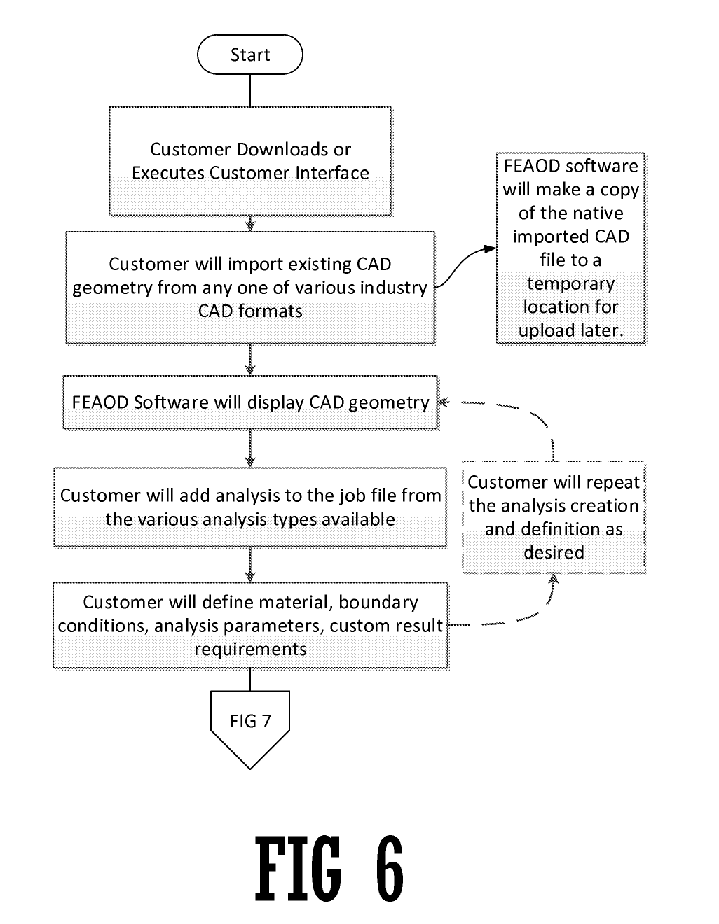

FIG. 7 is a flow diagram of an embodiment of the Client Finite Element Submission System showing a portion of the flow of the system.

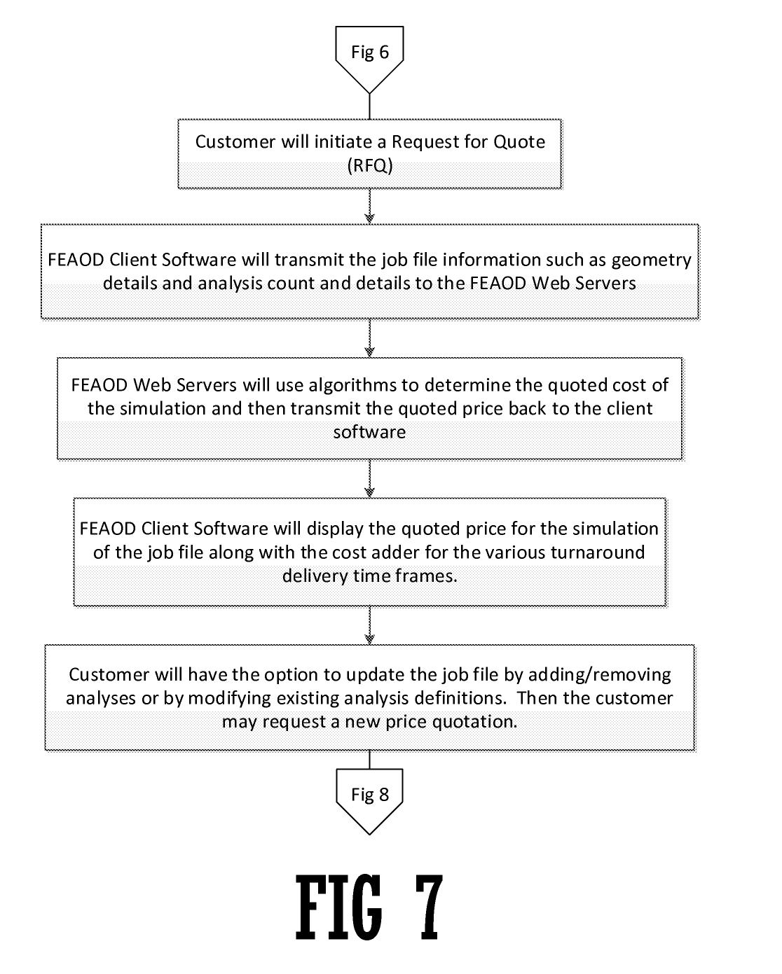

FIG. 8 is a flow diagram of an embodiment of the Client Finite Element Submission System showing a portion of the flow of the system.

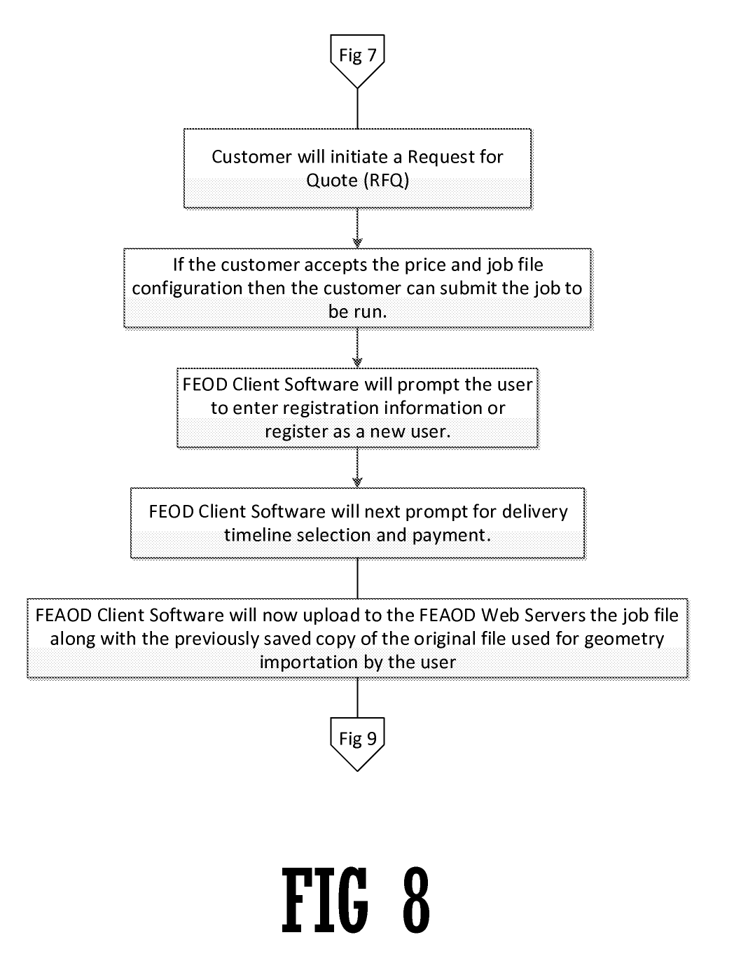

FIG. 9 is a flow diagram of an embodiment of the Client Finite Element Submission System showing a portion of the flow of the system.

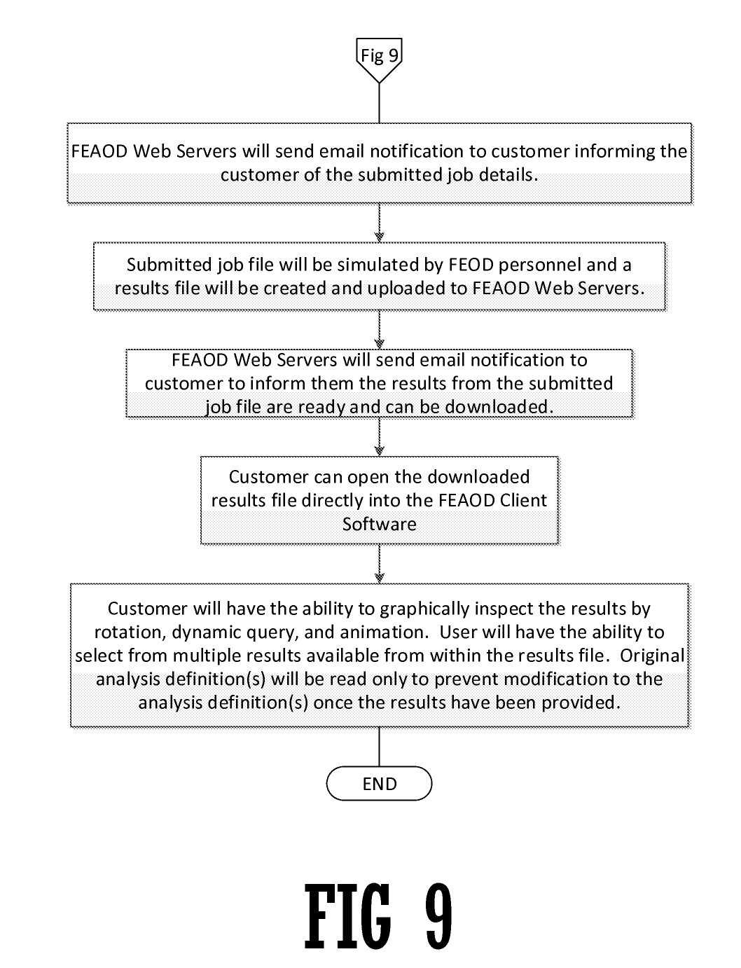

FIG. 10 is an image of the graphical user interface (GUI) for an embodiment of the Client Finite Element Submission System.

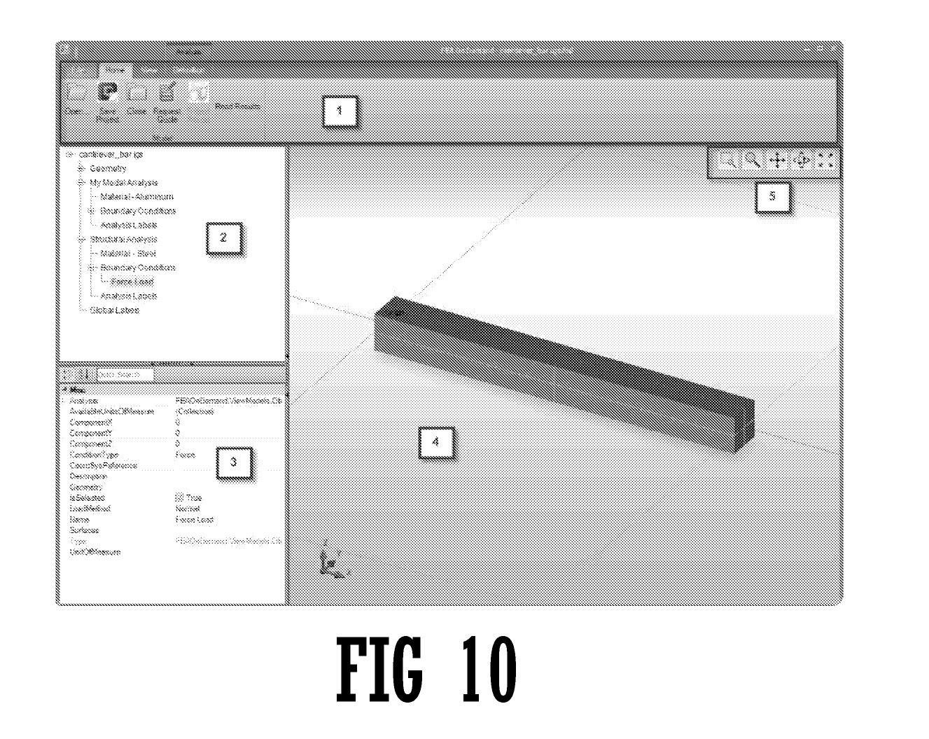

### DETAILED DESCRIPTION OF THE PREFERRED EMBODIMENTS

Embodiments of the Client Finite Element Submission System 100 are comprised of a pre-processing package, which generates a job file package, and a post-processing package. These packages are generated by an analysis step 101, a request for quote step 102, a job submission step 103, and a step that allows the user to view the results 104.

The pre-processing package is comprised of a means to allow the user to create the job file package to be submitted to the Finite Element Analysis (FEA) professional. The job file package will include the geometry to be analyzed, simulation type specifications, material specifications, boundary conditions, and custom result requests. The geometry of the design will be specified by the user through a graphical user interface that allows the user to import the 1D, 2D or 3D geometry into the job file package from various major industrial native CAD file formats (Pro/Engineer, Solidworks, Inventor, etc.) and commonly used exchange file formats (e.g. STEP, IGES, Parasolid, etc.). This geometry along with the analysis, material, and boundary condition specifications will be saved as a proprietary binary file format in a computer readable format on a computer readable medium. This will be the basic design and simulation request to be submitted to the FEA professional for analysis.

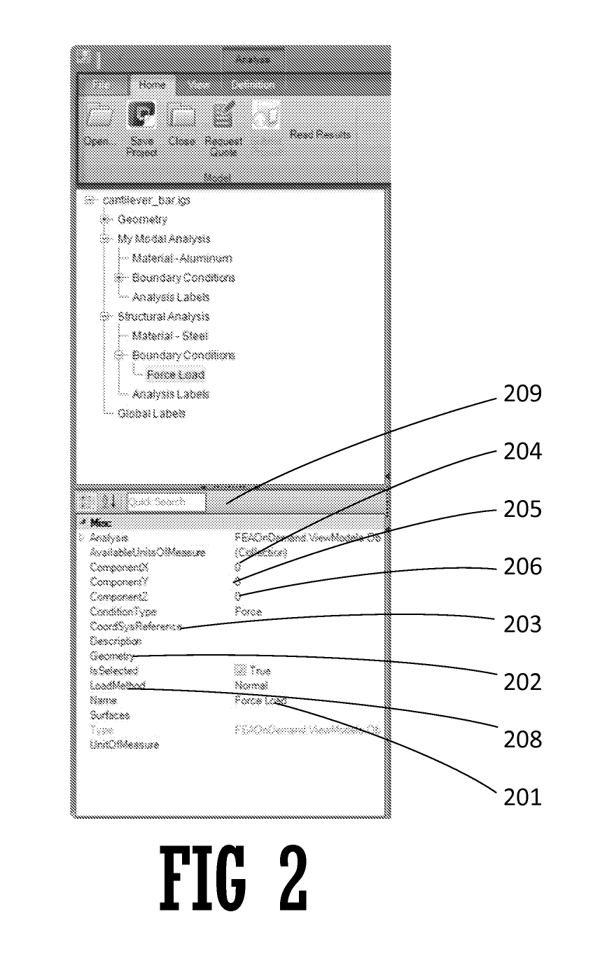

The pre-processing package comprises as part of a visual interface an analysis tree which is displayed to the user on a computer display. See FIG. 2. This analysis tree displays in hieratical form the multiple analysis models specified by the user.

The pre-processing package comprises the means to allow the user to specify multiple analysis models. Each analysis model will appear in the analysis tree as a new branch. In addition the user will have the ability to duplicate or copy each analysis branch to create another analysis branch. The user will declare or create what type of analysis will be done on each analysis branch. The user will declare material from a predefined list or create a custom material. The user will also be able to define various structural or thermal boundary conditions on the design. After the analysis job package is specified the user will have the ability to request a quote for the simulation from the FEA professional. The user defined job file package will either be submitted by the pre-processing package to the quotation servers where custom algorithms will be utilized by sever side software to determine the quotation price based on the submitted job file package or the pre-processing package software itself will process the job file package against internal algorithms to determine the quotation price based on the submitted job file package or the analyst will prepare the quotation based on the job file submission. The quotation will include the cost for the simulation of the entire job package as well as optional costs for expedited delivery of results and any applicable taxes or fees. The pre-processing package or server side software will return a quotation to the user at which point the user can decide to accept the quote and terms, log in and register to the server software and pay and specify payment options including payment options via credit card.

The client user can use the pre-processing package to define a three-dimensional finite element analysis problem, define basic analysis requirements, and create a finite element analysis job file. The client user can submit the finite element analysis problem file to a finite element analysis professional or computational service provider for computational services, and the finite element analysis professional or computational service provider uses a third party software packages to compute or simulate the job file and produce a solution file. The finite element analysis job file is comprised of a one, two, or three dimensional computer application design model geometry with one or multiple analysis definitions where each analysis definition defines the material, analysis type, boundary conditions, analysis options if required, and additional result requests. The analysis professional creates a results file that will be viewable by the analysis professional software application, and the client user is notified of the availability of the solution. The client user can download a FEA solution file that the client user can interpret and view the finite element analysis solution by dynamically rotating results to facilitate review of results, review analysis setup conditions, dynamically query results on the surface of the 3D model, and animate results. The result file is parsed by the software program file to allow the client user to move, rotate, zoom in, zoom out on the computer screen the finite element analysis solution developed by the finite element analysis professional or computational service provider. The client user can make low level changes to the FEA solution to resubmit to the FEA Professional. The client user can select shipping options and submit these options as part of the job file specification and quotation.

The post-processing package is comprised of a job file package which in turn is comprised of one or more simulations wherein each simulation can involve one or more simulation options, specification of a modal simulation, and specification of one to four natural frequency calculations to be performed.

All embodiments of the Client Finite Element Submission System 100 can be stored on non-transitory computer-readable medium. Non-transitory computer-readable medium is broadly defined to include any kind of electronic computer memory such as, but not limited to, floppy disks, conventional hard disks, CD-ROMs, CD-RAMs, DVD-ROMs, DVD-RAMs, Flash ROMS, nonvolatile ROM, RAM, and USB Flash Drives.

At this point the user will submit the design and for analysis by the FEA professional. Upon submission the user will receive an email containing the job number and other details pertaining to the submission process. The job file package is comprised of one or more simulations. Each simulation is comprised of geometry specifications, material specifications, boundary condition specifications, analysis type specifications, custom result requests, and one or more simulation options.

Once the design is complete the user will receive a completion email acknowledgement with a URL link providing a means to download the results file. The Client Finite Element Submission System application allows the user to review the results. There will be a results tab that will be enabled that allows the user to view results in terms of different types of results including displacement magnitudes, stresses and other engineering metrics. The user will also be able to have basic animation to be able to rotate the result and to view the result with different analysis results displayed. The user will also be allowed to dynamically query the result to investigate the design returned from the FEA professional. The user will be able to review the original model definition supplied to the FEA professional at the time of submission and compare that original model to the result returned from the FEA professional.

There is a plurality of analysis types that could be specified by the user and performed by the FEA professional. The plurality of analysis types includes structural, modal, pre-stress static structural and pre-stressed modal thermal and coupled thermal structural analysis. The structural analysis is a standard static structural analysis for a single component or multi-component assembly and this analysis will include analysis of structural loads and constraints. The modal analysis will be either an unconstrained or constrained modal analysis. If the analysis definition does not contain constraints the analysis will be considered an unconstrained modal analysis. In the modal analysis only constraints are available. There are no options for applied loading pertaining to modal analyses themselves and the user must select the number of modes or the frequency range to be analyzed. Default mode number will be 4. In the pre-stress static structural analysis type all loads and constraints are available and in this analysis type the user must select a prior structural analysis to proceed. In the pre-stressed modal analysis type only constraints are available. There are no options for applied loading and the user must select a prior structural analysis type to select this. The user must select a number of modes or the frequency range and if the user does not select a frequency range a default mode number 4 will be used. In the thermal analysis type basic heat transfer will be used in the FEA analysis method to determine the temperature gradients throughout the part. In the coupled thermal structural analysis type elements of both the structural analysis type and the thermal analysis type will be performed to analyze the thermal distribution, gradients, and thermal strains.

Defining the types of objects that will be done on the various analysis types as follows. Force will be defined as vectors normal to the surface or vector components based on a default coordinate system or a user defined coordinate system. For example, the x-component 204, the y-component 205, and the z-component 206 of force is specified when rectangular Cartesian coordinates are specified 203. The name of the force can be specified 201 along with choice of selecting the geometry 202. The method of loading the force either in normal mode or shear, can be specified 208. Also, a method of searching for forces already specified is supplied 209. Units of the vector force will be provided for, but not for individual vector components. Each vector component must have the same units associated with it. Pressure will act as a normal force per unit area to the surface based on the magnitude of the pressure selected by the user. The user will be able to select the units of pressure. Torque and moment will be based on a vector based on surface normal and magnitude. The user will be able to supply vector components and will also be allowed to select units for the overall vector but not for individual vector components. The user will be able to select a global temperature for the part. The user will supply starting temperatures and a final temperature and derived delta change in temperature will be displayed in a dialog box. Units can be selected between Fahrenheit, Celsius, Rankine, or Kelvin units. Standard earth gravity of 386.4 inches per second squared will be the default magnitude of gravity. The application allows a single instance per analysis of the definition of this load type. The user will have a scaling factor to alter the gravitational constant. The default value will be set at 1 and the resulting default acceleration value will be scaled accordingly if this scaling factor changes. The user will have the ability to select the global acting direction of the standard earth gravity as shown in FIG. 2. The user will be able to specify acceleration and the acceleration will be vector based on surface normal and magnitude. It will be based in vector components and once again the user will be able to select the units for the overall vector but not for individual components of the vector. The user will be able to select bearing loads which will also be vector based on surface normal magnitude and will be based on vector components. The user will be able to select the overall units of the vector components but not individual vector component units. In addition the embodiments will include a custom coordinate system creation as well as other enhancements to the user.

Embodiments of the Client Finite Element Submission System 100 also also includes a custom coordinate system creation, surface region definition, thermal simulations, coupled thermal—structural, hydrostatic load, rotational velocity load, rotational acceleration load, pre-stressed static analysis, pre-stressed modal analysis.

Multi-component assemblies provide the graphical interface with the ability to setup both single component simulations, but also multi component simulations. Therefore, the user interface will provide the ability for the user to specify the material properties for each of the components as well as connections between the components that will tell the fea professional how to treat common boundaries (i.e. two touching surfaces could be treated as bonded, no contact, frictionless contact, or frictional contact).

Embodiments of the Client Finite Element Submission System 100 also allows for either single parts that have self-contact or contact between multiple components or bodies. The contact between surfaces would be treated as frictionless, frictional, or bonded.

Embodiments of the Client Finite Element Submission System 100 also account for large deformations that allows users to include non-linear large deformation effects. Structures that when subject to loading experience large amounts of deformation can have simulation results that are inaccurate if large deformation effects are not taken into consideration. All FEA codes and solid mechanics for that matter is based on small strain theory, which aids in the solution of the complex equations by eliminating the trigonometric terms from all the equations. It is essentially an accurate assumption assuming that the deformations are small. If the deformations are large then a non-linear simulation would be required that would account for the large deformations, ultimately resulting in more accurate solutions at the cost of additional computational time and effort.

Embodiments of the Client Finite Element Submission System 100 also account for plasticity and permanent deformation that allows the end user to include non-linear plasticity or permanent deformation effects. Most FEA simulations are performed linearly, therefore strains or stresses beyond the yield point of the material are not considered. An option to include plasticity effects allows for determination of stresses and strains beyond the yield point of the material, which is required for structures experiencing permanent deformation or structural failure analysis.

Embodiments of the Client Finite Element Submission System 100 also account for hyper Elasticity that allows the end user to include non-linear hyper elasticity material effects. Hyper elasticity is phenomenon exhibited by hyper elastic materials such as elastomers or rubbers. For these materials they can experience very large strains without permanent deformation or damage. This requires special mathematics to handle the large non-linear strains. The increase in simulation accuracy comes as the cost of increased computational time.

Embodiments of the Client Finite Element Submission System 100 also provide for multi-volume Bodies that allows the end user to prescribe a single component to have two separate material properties. This is useful for bi-metallic components or over molded components.

Embodiments of the Client Finite Element Submission System 100 also account for springs that allows the end user to create idealized springs to participate within the simulation. These springs can be simple extensional, torsional, a combination of extensional and torsional, directional springs (i.e. Cartesian, Cylindrical, Spherical), etc. In addition, these springs can include preload or damping properties. The end user will need to specify the spring end locations as well as the type and specific properties of the springs.

Embodiments of the Client Finite Element Submission System 100 also account for idealized masses that allow end users to attach an idealized mass to the component or multi-component assembly model. The masses will emulate larger mass components within the simulation model without having to explicitly model the entire idealized mass. The masses can be connected to the simulation geometry either with rigid connections or flexible connections.

Embodiments of the Client Finite Element Submission System 100 also account for connections that allow end users to specify rigid or flexible connections between two or more different components or different surfaces within the same component. In addition, this enhancement allow end users to specify a special type of connection that will emulate spot welds.

Embodiments of the Client Finite Element Submission System 100 also account for beams that allows the end user to create idealized beams within the simulation model or models. This allows for the simulation of large structures such as towers and trusses more efficiently.

The method of using the Embodiments of the Client Finite Element Submission System 100 and transferring model information from client to finite element analysis professional or computational service provider is comprised of the steps. The first step of the user creating one or more multiple analysis models wherein each analysis module will appear in the analysis tree as a separate branch, and wherein the user will have the ability to duplicate an analysis branch 300 which will include uploading a 3D CAD model 301. The next step where the user will declare or create new analysis type 302. The next step where the user will declare material form predefined list or create custom material or materials 303. The next step where the user will define or create boundary conditions and other analysis settings on the proposed design 304, adding custom result options 305, and other additional analysis requirements 306.

The next series of steps can be termed as the main submission steps 400. The next step where the user will choose a delivery option and timeframe 402. The next step where the user will submit the job file package for a quote from the FEA professional or computational service provider 403. The next step wherein the server based software application receives the request for quotation for viewing by the client. The next step wherein the server side application will return a quotation to the pre-processing package software for display of the quotation to the user 404. The next step where the user will reject the quote 405 or accept the quote and specify the payment terms 406. The user is permited to register in the system or login for existing users 502. The user is permitted to select a method of payment 503 and agree to the terms of use of the system 504. The user is allowed to confirm a final checkout or submission 505. The next step wherein the FEA professional, computational service provider, or server based application returns a submission receipt to the user and an email stating job number 506 and otherwise confirming the completion of the submission 507.

The next step wherein the FEA professional, computational service provider, or server based application returns a completion email to the user containing a link for downloading a results file 903. The next step where the user will download results file or select the required results from the user interface 904. The final step where the user will review results file 905.

What I claimed is:

1. A non-transitory computer-readable medium having computer-executable instructions for a client finite element analysis submission system comprised of
a. a pre-processing package which generates a job file package; and
b. a post-processing package.

2. A non-transitory computer-readable medium having computer-executable instructions for a client finite element analysis submission system in claim 1 wherein the job file package is comprised of
a. one or more simulations wherein each simulation can involve one or more simulation options;
b. the specification of a modal simulation; and
c. the specification of one to four natural frequency calculations to be performed.

3. A non-transitory computer-readable medium having computer-executable instructions for a client finite element analysis submission system in claim 2 wherein
a. the client user uses the pre-processing package to define a three-dimensional finite element analysis problem, define basic analysis requirements, and create a finite element analysis job file; and
b. the client user submits the finite element analysis problem file to a finite element analysis professional or computational service provider for computational services.

4. A non-transitory computer-readable medium having computer-executable instructions for a client finite element analysis submission system in claim 3 wherein
a. the finite element analysis professional or computational service provider uses a third party software packages to compute or simulate the job file and produce a solution file;
b. the finite element analysis job file comprised of a one, two, or three dimensional computer application design model geometry with one or multiple analysis definitions;
c. each analysis definition defines the material, analysis type, boundary conditions, analysis options if required, and additional result requests;
d. the analysis professional creates a results file that will be viewable by the analysis professional software application; and
e. the client user is notified of the availability of the solution.

5. A non-transitory computer-readable medium having computer-executable instructions for a client finite element analysis submission system in claim 4 wherein the client user can download a FEA solution file that the client user can interpret and view the finite element analysis solution by dynamically rotating results to facilitate review of results, review analysis setup conditions, dynamically query results on the surface of the 3D model, and animate results.
a. the result file is parsed by the software program file to allow the client user to move, rotate, zoom in, zoom out on the computer screen the finite element analysis solution developed by the finite element analysis professional or computational service provider;
b. the client user can make low level changes to the FEA solution to resubmit to the FEA Professional; and
c. the client user can select shipping options and submit these options as part of the job file specification and quotation.

6. A non-transitory computer-readable medium having computer-executable instructions for a client finite element analysis submission system in claim 5 wherein upon return of the completed problem solution from the element analysis professional, the user can view the results of the analysis including mousing over the result and viewing the result in animated form.

7. A non-transitory computer-readable medium having computer-executable instructions for a client finite element analysis submission system wherein the method of transferring model information from client to finite element analysis professional or computational service provider is comprised of the steps:
a. first step of the user creating one or more multiple analysis models wherein each analysis module will appear in the analysis tree as a separate branch, and wherein the user will have the ability to duplicate an analysis branch;
b. the next step where the user will declare or create new analysis type;
c. the next step where the user will declare material form predefined list or create custom material or materials;
d. the next step where the user will define or create boundary conditions on the proposed design;
e. the next step where the user will choose a delivery option and timeframe;
f. the next step where the user will submit the job file package for a quote from the FEA professional or computational service provider;
g. the next step wherein the server based software application receives the request for quotation;
h. the next step wherein the server side application will return a quotation to the pre-processing package software for display of the quotation to the user;
i. the next step where the user will reject the quote or accept the quote and specify the payment terms;
j. the next step wherein the FEA professional, computational service provider, or server based application returns a submission receipt to the user and an email stating job number and other details;
k. the next step wherein the FEA professional, computational service provider, or server based application returns a completion email to the user containing a link for downloading a results file;
l. the next step where the user will download results file or select the required results from the user interface; and
m. the final step where the user will review results file.
